(19) United States
(12) Patent Application Publication
(10) Pub. No.: US 2011/0314416 A1
(43) Pub. Date: Dec. 22, 2011

(54) COLLECTED MEDIA CONTENT DATA

(75) Inventors: Chad C. Gibson, Seattle, WA (US); Geir O. Martinsen, Seattle, WA (US)

(73) Assignee: MICROSOFT CORPORATION, Redmond, WA (US)

(21) Appl. No.: 12/817,849

(22) Filed: Jun. 17, 2010

(51) Int. Cl. G06F 15/16; G06F 3/048

(52) U.S. Cl. 715/810; 709/217

(57) ABSTRACT

Collected media content data is described. In embodiments, browsing inputs are received from a client device when a user interacts with the client device to browse media content available via the Internet. Media content data associated with the media content that is displayed for viewing at the client device can be collected, and media items that are associated with the media content data can be determined. Identifiers of the media items that are correlated with the user can be stored, and the identifiers of the media items then communicated to a media content playback device that is associated with the user.

### BACKGROUND

Media content choices, such as movies, music, television programs, games, videos, and other types of entertainment media content are ever-increasing. Users can browse the Internet for directories and schedules of television programs, movies, games, and video content, such as at a television guide Web site, or at a video provider's directory. Media content and/or entertainment media content that is related to television programs, movies, games, and/or videos are typically popular Internet search topics. After a user determines viewing options and choices from an Internet search, such as when utilizing a computer device, the user will likely switch to a different device or system to watch a viewing choice, or participate in on-line gaming.

### SUMMARY

This summary is provided to introduce simplified concepts of collected media content data that are further described below in the Detailed Description. This summary is not intended to identify essential features of the claimed subject matter, nor is it intended for use in determining the scope of the claimed subject matter.

Collected media content data is described. In embodiments, browsing inputs are received from a client device when a user interacts with the client device to browse media content (e.g., to include entertainment media content) available via the Internet. Media content data associated with the media content that is displayed for viewing at the client device can be collected, and media items that are associated with the media content data can be determined. Identifiers of the media items that are correlated with the user can be stored, and the identifiers of the media items then communicated to a media content playback device that is associated with the user.

In other embodiments, the media content data can be received from the client device when an explicit user input at the client device initiates selection of the media content data for collection. Alternatively or in addition, the media content data can be received from the client device when a browser module that is implemented at the client device selects the media content data based on media tags that identify the media content data. Alternatively or in addition, the media content data can be received from the client device when a browser module that is implemented at the client device selects the media content data based on semantic identification of the media content data.

In other embodiments, the identifiers of the media items are displayable at the media content playback device as user-selectable references to the media items. A user selection of an identifier of a media item can be received from the client device, and the media item that corresponds to the identifier then delivered for playback at the media content playback device. For example, the media content playback device can be implemented as a television client system to display the identifiers of the media items for user selection to initiate playback of a media item.

### BRIEF DESCRIPTION OF THE DRAWINGS

Embodiments of collected media content data are described with reference to the following drawings. The same numbers are used throughout the drawings to reference like features and components:

FIG. 1 illustrates an example system in which embodiments of collected media content data can be implemented.

FIG. 2 illustrates an example of collected media content data in accordance with one or more embodiments.

FIG. 3 illustrates an example system with multiple devices that can implement various embodiments of collected media content data for a seamless user experience in ubiquitous environments.

FIG. 4 illustrates example method(s) of collected media content data in accordance with one or more embodiments.

FIG. 5 illustrates additional example method(s) of collected media content data in accordance with one or more embodiments.

FIG. 6 illustrates various components of an example device that can implement embodiments of collected media content data.

### DETAILED DESCRIPTION

Collected media content data is described. In embodiments, media content data is collected that relates to media content when a user interacts with a client device to browse the media content available via the Internet. The collection of media content data integrates Internet browsing activity with viewing television content. For example, media items that are related to the media content (e.g., to include entertainment media content) that has been browsed via the Internet may be selectable for playback when the user later initiates a television, or similar media content playback device, to watch television programming, movies, videos, participate in games, and the like. The media content data can be collected at one or more client devices that a user utilizes to browse the media content and/or entertainment media content. The media content data can then be uploaded to a media content service that determines media items related to the media content data. Alternatively or in addition, the media content data can be collected at the media content service.

While features and concepts of the described systems and methods for collected media content data can be implemented in any number of different environments, systems, and/or various configurations, embodiments of collected media content data are described in the context of the following example systems and environments.

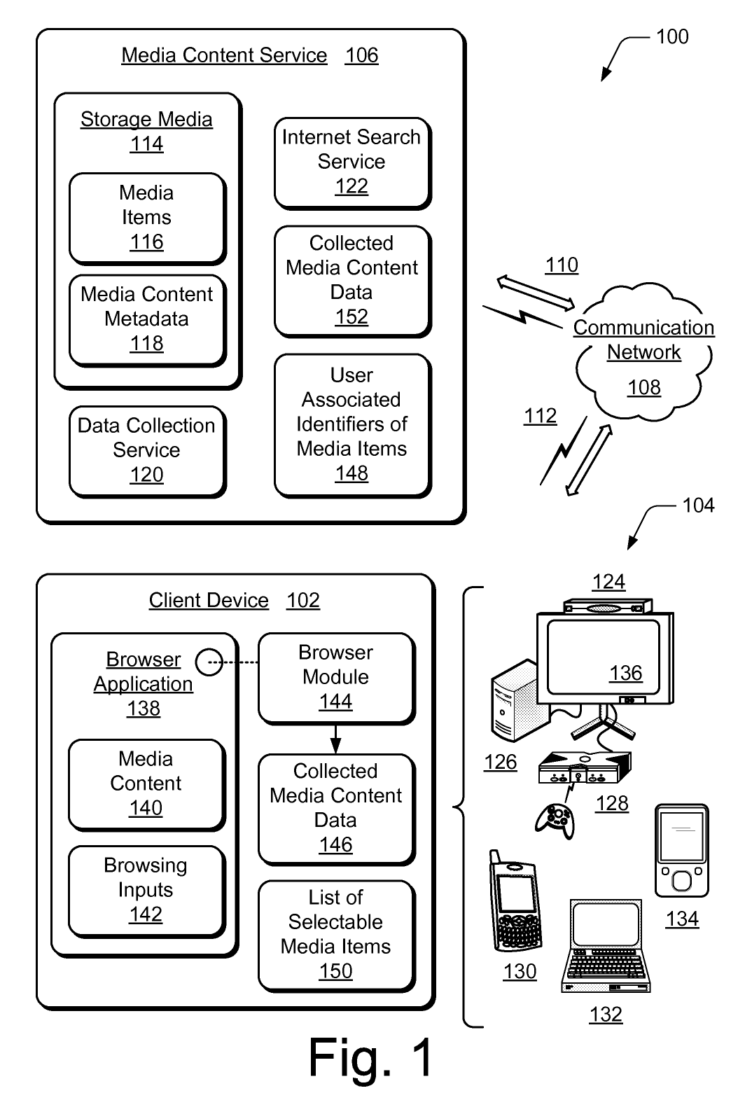

FIG. 1 illustrates an example system 100 in which various embodiments of collected media content data can be implemented. The example system 100 includes a client device 102, which may be configured as any type of client device 104. Some of the various client devices 104 include wired and/or wireless devices, and may also be referred to as user devices and/or portable devices. The example system 100 also includes a media content service 106 and/or other media content sources that communicate or otherwise provide media content and data to any number of the various client devices 104 via a communication network 108.

The communication network 108 can be implemented to include a broadcast network, an IP-based network 110, and/or a wireless network 112 that facilitates media asset distribution and data communication between the media content service 106 and any number of the various client devices. The communication network 108 can also be implemented using any type of network topology and/or communication protocol, and can be represented or otherwise implemented as a combination of two or more networks. The communication network 108 may also include a mobile operator network that is managed by a communication service provider, such as a cell-phone provider and/or Internet service provider, to facilitate mobile data and/or voice communications for any type of a wireless device or mobile phone (e.g., cellular, VoIP, Wi-Fi, etc.).

The media content service 106 can include media content servers to communicate, or otherwise distribute, media content and/or other data to any number of the various client devices. In this example system 100, the media content service 106 includes storage media 114 to store or otherwise maintain various media content and data, such as media items 116 and media content metadata 118. The storage media 114 can be implemented as any type of memory and/or suitable electronic data storage. Additionally, the media content service 106 may be implemented as a subscription-based service from which any of the various client devices 104 can request media items 116, or recommendations of media items, to download and display for viewing, or otherwise render for playback. The media content service 106 manages distribution of media content to the various client devices 104, such as when a request for a media item 116 is received from a client device 104, and the media content service 106 communicates or provides data segments of the media item to the client device.

The media items 116 (e.g., also referred to as media assets) can include any type of audio, video, and/or image data received from any type of media content source or data source. As described throughout, media items are media content (e.g., to include entertainment media content), and media items can include music (e.g., digital music files), television programming, movies, on-demand media assets, interactive games, network-based applications, and any other audio, video, and/or image data (e.g., to include program guide data, user interface data, advertising content, closed captions data, content metadata, search results and/or recommendations, etc.). The media content metadata 118 can include any type of identifying criteria, descriptive information, and/or attributes associated with the media items 116 that describes and/or categorizes the media items. For example, metadata can include a media item identifier, title, subject description, a date of production, artistic information, music compilations, and any other types of descriptive information about a particular media item.

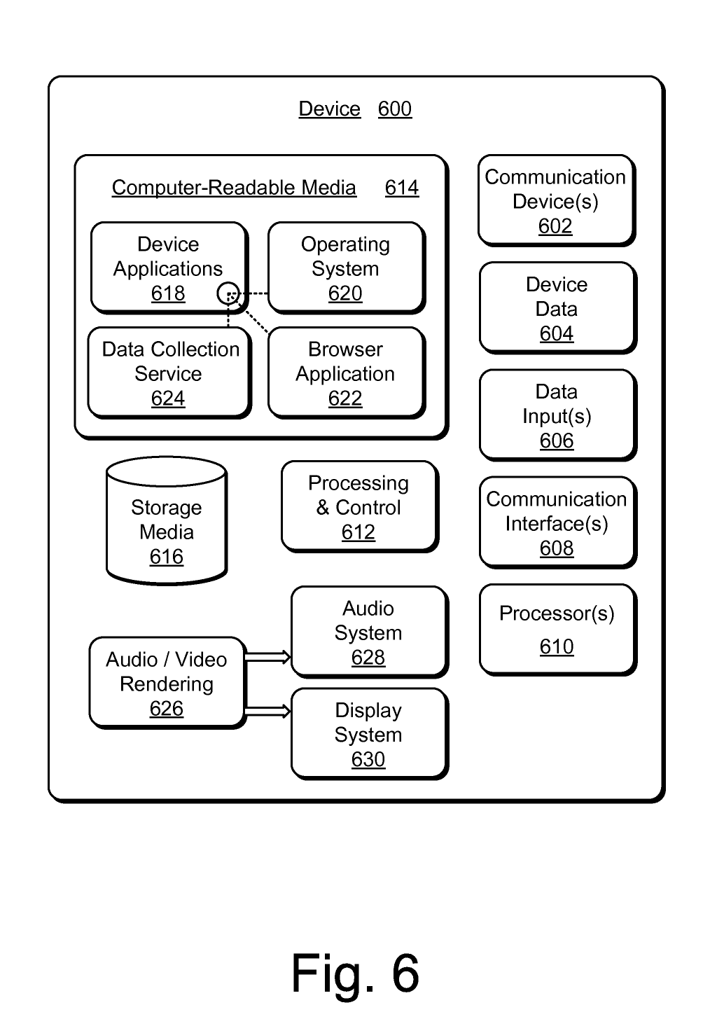

In this example system 100, the media content service 106 includes a data collection service 120 that can be implemented as computer-executable instructions and executed by one or more processors to implement the various embodiments described herein for collected media content data. The media content service 106 may also include an Internet search service 122 that can be implemented as computer-executable instructions and executed by one or more processors to implement the various embodiments described herein for collected media content data. The media content service 106 can also be implemented with any number and combination of differing components as further described with reference to the example device shown in FIG. 6. Additionally, any of the media content service 106, the data collection service 120, and the Internet search service 122 may be implemented as an independent service (e.g., on a separate server or by a third party service), or as one combined service.

In the example system 100, a client device 104 can be implemented as any one or combination of a television client device 124 (e.g., a television set-top box, a digital video recorder (DVR), etc.), a computer device 126, a gaming system 128, an appliance device, an electronic device, and/or as any other type of client device or user device that may be implemented to receive media content in any form of audio, video, and/or image data. The various client devices 104 can also include wireless devices implemented to receive and/or communicate wireless data, such as any one or combination of a mobile phone 130 (e.g., cellular, VoIP, WiFi, etc.), a portable computer device 132, a media device 134 (e.g., a personal media player, portable media player, etc.), and/or any other wireless device that can receive media content in any form of audio, video, and/or image data. A client system can include a respective client device and display device 136 that together render or playback any form of audio, video, and/or image media content and media assets. The display device 136 can be implemented as any type of a television, high definition television (HDTV), LCD, or similar display system.

Any of the various client devices 104 can be configured as the client device 102 and implemented with one or more processors, communication components, memory components, signal processing and control circuits, and a media content rendering system. Further, any of the client devices 104 can be implemented with any number and combination of differing components as further described with reference to the example device shown in FIG. 6. The example client device 102 includes a browser application 138 that is implemented for browsing media content 140 available via the Internet. For example, the client device 102 receives browsing inputs 142, such as when a user interacts with the client device 102 to browse media content available via the Internet.

The client device may also include a browser module 144 that is an application plug-in for the browser application 138, and can be downloaded and installed on any of the various client devices 104 to implement embodiments of collected media content data. The browser module 144 is implemented to collect media content data 146 associated with the media content 140 that is displayed for viewing at the client device (e.g., on the display device 136). In an embodiment, an explicit user input to select the media content data for collection can be received. For example, a user may drag a displayed object on a user interface to a data collection drop region of the user interface, such as a region that is implemented by the browser module 144 and integrated in a user interface browser. Alternatively or in addition, the browser module 144 is implemented to select the collected media content data 146 based on media tags that identify the media content data, and/or based on semantic identification of the media content data. The media tags may include meta tags at a Web page, or other media content identifiers. Semantic identification of media content data may include identifying media content data, such as names of people, music, or movies using natural language techniques or other methods to infer media content data from a Web page.

The client device 102 can communicate the collected media content data 146 to the media content service 106 where the data collection service 120 is implemented to determine media items 116 that are associated with the media content data. Identifiers of the media items are then stored at the media content service 106 and correlated with a user, such as the user of client device 102. The identifiers are stored as the user associated identifiers 148 of media items. The media content service 106 can then communicate the identifiers 148 of the media items to a media content playback device that is associated with the user. For example, the client device 102 (e.g., implemented as a television set-top box) can receive the identifiers 148 of the media items as a list of selectable media items 150 for display as user-selectable references to the media items (e.g., displayed on the display device 136). The list of selectable media items 150 can be populated in a queue or list of relevant items that relate to the previous media content searches when the user browsed the media content via any of the various client devices 104 that are associated with the user.

It should be noted that in this discussion, the client device 102 may initially represent any of the various client devices configured for browsing media content that is available via the Internet, such as the portable computer device 132. A user that browses the Internet for media content may also be associated with the television client device 124 via which the user receives and watches television programs, movies, videos, and the like (e.g., media items 116). The user may browse the media content 140 from several different client devices 104, and the list of selectable media items 150 correlates to the collected media content data that is collected from the several different client devices, and later displayed for user selection, such as on a television display device.

In alternate embodiments, a client device may not include the browser module 144 to collect the media content data. Alternatively, the Internet search service 122 at the media content service 106 receives browsing inputs from the client device 102 when the user interacts with the client device to browse the media content 140 that is available via the Internet. The Internet search service 122 is implemented to collect media content data 152 associated with the media content 140 that is displayed for viewing at the client device 102. The Internet search service 122 also determines media items 116 that are associated with the collected media content data 152. Identifiers of the media items are then stored at the media content service 106 as the user associated identifiers 148 of media items.

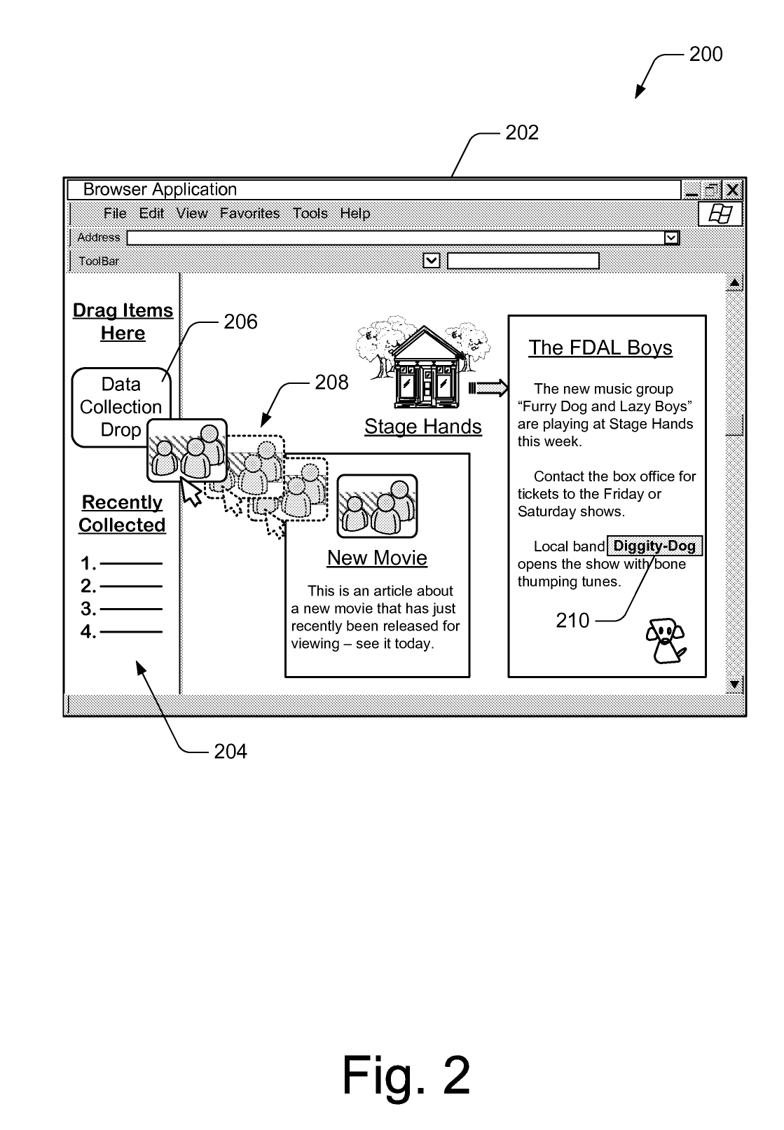

FIG. 2 illustrates an example 200 of the embodiments described herein for collected media content data. A user interface 202, such as for a browser application, can be displayed at any of the various client devices 104 described with reference to FIG. 1. In this example, the user interface 202 is representative of a Web page that includes information pertaining to entertainment media content, such as when a user at a client device browses for media content related to movies, television programs, and music that may be of interest to the user. The user interface includes a data collection region 204, such as may be implemented by the browser module 144 as a plug-in extension that integrates with the browser application 138 for collection of media content data. The data collection region 204 includes a data collection drop 206 where a user can drag a displayed object 208, such as a picture or text of a new movie, on the user interface to collect the media content data. Alternatively or in addition, media content data on the user interface page can be identified by the browser module 144, such as the name of a music group at 210 that is identified in the text of the announcement for the music performances.

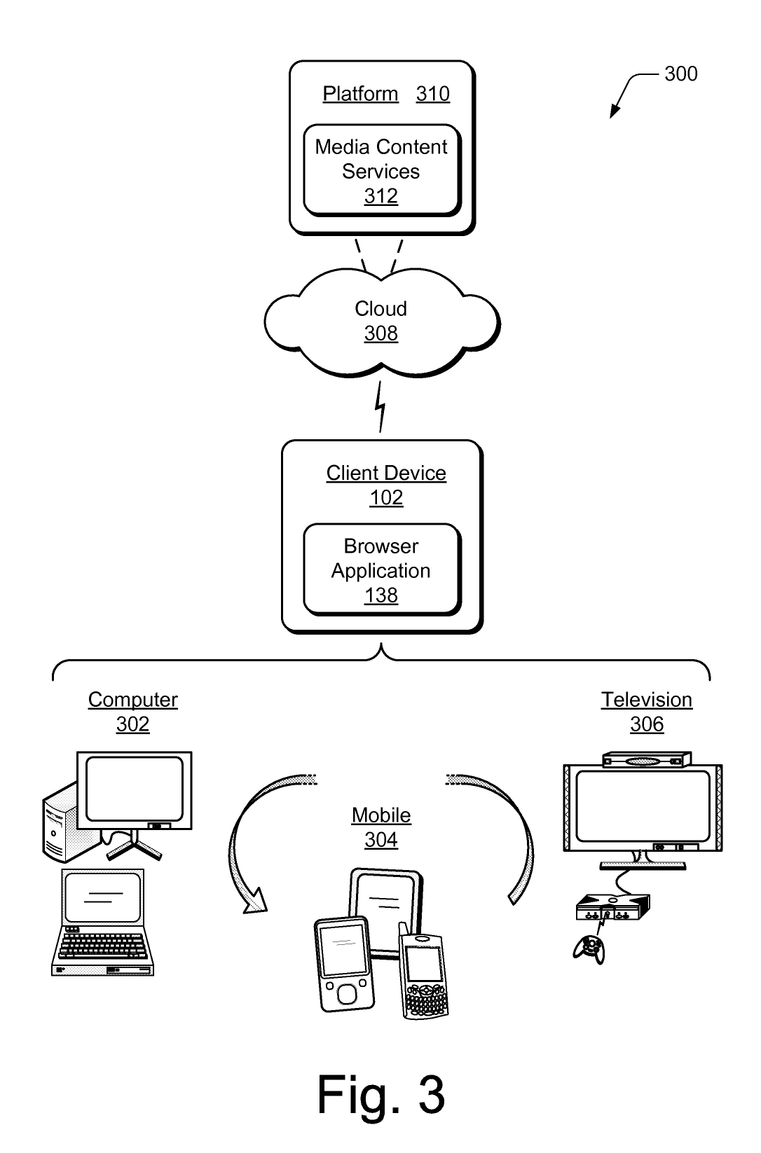

FIG. 3 illustrates an example system 300 that includes the client device 102 as described with reference to FIG. 1. The example system 300 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 300, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the client device 102 may assume a variety of different configurations, such as for computer 302, mobile 304, and television 306 uses. Each of these configurations includes devices that may have generally different constructs and capabilities, and thus the client device 102 may be configured according to one or more of the different device classes. For instance, the client device 102 may be implemented as the computer 302 class of device that includes a personal computer, desktop computer, a multi-screen computer, laptop computer, netbook, and so on.

The client device 102 may also be implemented as the mobile 304 class of device that includes mobile devices, such as a mobile phone, portable music player, portable gaming device, a tablet computer, a multi-screen computer, and so on. The client device 102 may also be implemented as the television 306 class of device that includes devices having or connected to generally larger screens in casual viewing environments. These devices include televisions, set-top boxes, gaming consoles, and so on. The techniques described herein may be supported by these various configurations of the client device 102 and are not limited to the specific examples of collected media content data described herein.

The cloud 308 includes and/or is representative of a platform 310 for media content services 312. The platform 310 abstracts underlying functionality of hardware (e.g., servers) and software resources of the cloud 308. The media content services 312 may include applications and/or data that can be utilized while computer processing is executed on servers that are remote from the client device 102. For example, the media content services 312 may include the media content service 106, the data collection service 120, and/or the Internet search service 122 as described with reference to FIG. 1. Media content services 312 can be provided as a service over the Internet and/or through a subscriber network, such as a cellular or WiFi network.

The platform 310 may abstract resources and functions to connect the client device 102 with other computing devices. The platform 310 may also serve to abstract scaling of resources to provide a corresponding level of scale to encountered demand for the media content services 312 that are implemented via the platform 310. Accordingly, in an interconnected device embodiment, implementation of functionality of the browser application 138 and/or the browser module 144 may be distributed throughout the system 300. For example, the browser application 138 and/or the browser module 144 may be implemented in part on the client device 102 as well as via the platform 310 that abstracts the functionality of the cloud 308.

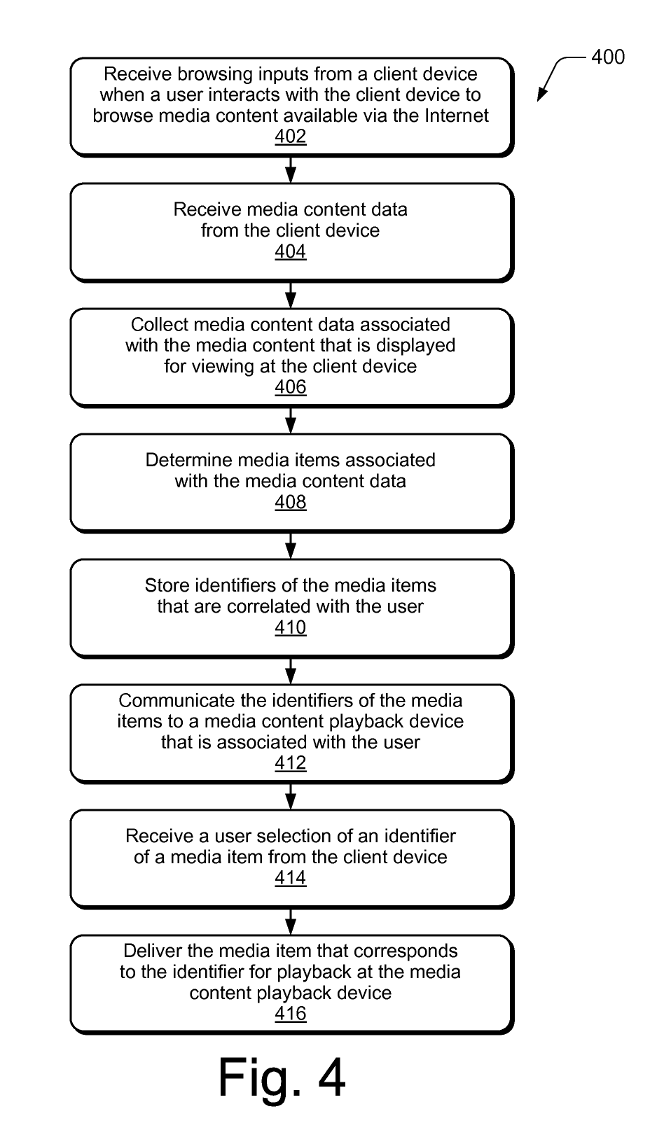

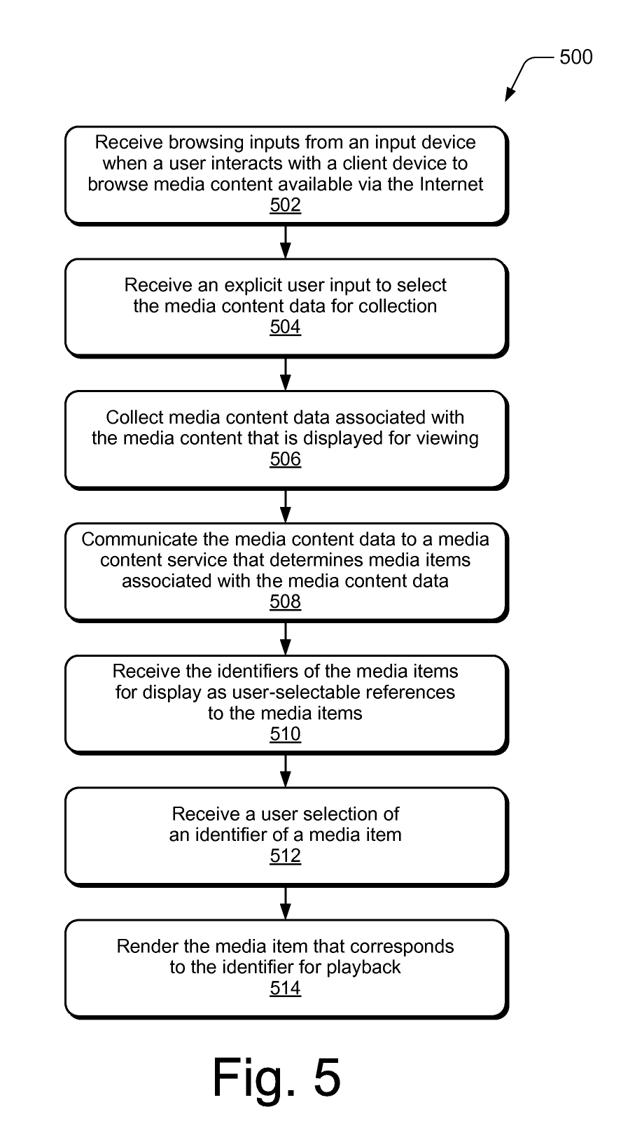

Example methods 400 and 500 are described with reference to respective FIGS. 4 and 5 in accordance with one or more embodiments of collected media content data. Generally, any of the functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computer devices. Further, the features described herein are platform-independent and can be implemented on a variety of computing platforms having a variety of processors.

FIG. 4 illustrates example method(s) 400 of collected media content data, and is described with reference to a data collection service. The order in which the method blocks are described are not intended to be construed as a limitation, and any number of the described method blocks can be combined in any order to implement a method, or an alternate method.

At block 402, browsing inputs are received from a client device when a user interacts with the client device to browse media content available via the Internet. For example, the Internet search service 122 at the media content service 106 receives browsing inputs from the client device 102 (e.g., or from any number of the various client devices 104) when a user interacts with the client device to browse the media content 140 that is available via the Internet.

At block 404, media content data is received from the client device. For example, the media content service 106 receives the collected media content data 152 from the client device 102, such as when an explicit user input at the client device initiates selection of the media content data for collection. Alternatively or in addition, the collected media content data 152 can be received from the client device when the browser module 144 at the client device selects the media content data based on media tags that identify the media content data and/or based on semantic identification of the media content data.

At block 406, media content data associated with the media content that is displayed for viewing at the client device is collected. For example, the data collection service 120 at the media content service 106 collects the media content data 146 associated with the media content 140 that is displayed for viewing at the client device (e.g., on the display device 136). At block 408, media items associated with the media content data are determined. For example, the data collection service 120 determines media items 116 that are associated with the media content data. At block 410, identifiers of the media items that are correlated with the user are stored. For example, the user associated identifiers 148 of media items are stored at the media content service 106 and correlated with the user, such as the user of client device 102.

At block 412, the identifiers of the media items are communicated to a media content playback device that is associated with the user. For example, the media content service 106 communicates the identifiers 148 of the media items to a media content playback device that is associated with the user, such as to the client device 102 (e.g., implemented as a television set-top box) that receives the identifiers 148 of the media items as a list of selectable media items 150 for display as user-selectable references to the media items (e.g., displayed on the display device 136).

At block 414, a user selection of an identifier of a media item is received from the client device and at block 416, the media item that corresponds to the identifier is delivered for playback at a media content playback device. For example, the media content service 106 receives a user selection of a selectable media item, and delivers the selected media item to a media content playback device, such as a television client system that displays the identifiers of the media items for user selection to initiate playback of a media item.

FIG. 5 illustrates example method(s) 500 of collected media content data, as is described with reference to a client device. The order in which the method blocks are described are not intended to be construed as a limitation, and any number of the described method blocks can be combined in any order to implement a method, or an alternate method.

At block 502, browsing inputs are received from an input device when a user interacts with a client device to browse media content available via the Internet. For example, the client device 102 (FIG. 1) receives browsing inputs 142, such as when a user interacts with the client device 102 to browse the media content 140 that is available via the Internet. At block 504, an explicit user input is received to select the media content data for collection. For example, the client device 102 receives an explicit user input to select media content data 146 for collection, such as when a user drags a displayed object 208 on a user interface 202 to a data collection drop 206 on the user interface.

At block 506, media content data associated with the media content that is displayed for viewing is collected. For example, the browser module 144 collects media content data 146 associated with the media content 140 that is displayed for viewing at the client device (e.g., on the display device 136). In embodiments, the media content data 146 can be collected when the browser module 144 selects the media content data based on media tags that identify the media content data and/or based on semantic identification of the media content data.

At block 508, the media content data is communicated to a media content service that determines media items associated with the media content data. For example, the client device 102 communicates the collected media content data 146 to the media content service 106 where the data collection service 120 determines media items 116 that are associated with the media content data, and the media content service stores identifiers of the media items that are correlated with the user.

At block 510, the identifiers of the media items are received for display as user-selectable references to the media items. For example, the client device 102 receives the identifiers 148 of the media items as a list of selectable media items 150 for display as user-selectable references to the media items (e.g., displayed on the display device 136). At block 512, a user selection of an identifier of a media item is received and, at block 514, the media item that corresponds to the identifier is rendered for playback. For example, the client device 102 receives a user selection of a selectable media item 150 for playback at the client device 102.

FIG. 6 illustrates various components of an example device 600 that can be implemented as any type of client, server, and/or computing device as described with reference to the previous FIGS. 1-5 to implement embodiments of collected media content data. In embodiments, device 600 can be implemented as any one or combination of a wired and/or wireless device, as any form of television client device (e.g., television set-top box, digital video recorder (DVR), etc.), consumer device, computer device, server device, portable computer device, user device, communication device, video processing and/or rendering device, appliance device, gaming device, electronic device, and/or as any other type of device. Device 600 may also be associated with a user (i.e., a person) and/or an entity that operates the device such that a device describes logical devices that include users, software, firmware, and/or a combination of devices.

Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as user-selectable inputs, messages, music, television media content, recorded video content, and any other type of audio, video, and/or image data received from any content and/or data source.

Device 600 also includes communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable instructions to control the operation of device 600 and to implement embodiments of collected media content data. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable storage media 614, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable storage media 614 provides data storage mechanisms to store the device data 604, as well as various device applications 618 and any other types of information and/or data related to operational aspects of device 600. For example, an operating system 620 can be maintained as a computer application with the computer-readable storage media 614 and executed on processors 610. The device applications 618 may include a device manager, such as any form of a control application, software application, signal processing and control module, code that is native to a particular device, a hardware abstraction layer for a particular device, and so on.

The device applications 618 also include any system components or modules to implement embodiments of collected media content data. In this example, the device applications 618 can include a browser application 622, such as when device 600 is implemented as a client device. Alternatively or in addition, the device applications 618 can include a data collection service 624, such as when device 600 is implemented as a media content service. The browser application 622 and the data collection service 624 are shown as software modules and/or computer applications. Alternatively or in addition, the browser application 622 and/or the data collection service 624 can be implemented as hardware, software, firmware, or any combination thereof.

Device 600 also includes an audio and/or video rendering system 626 that generates and provides audio data to an audio system 628 and/or generates and provides display data to a display system 630. The audio system 628 and/or the display system 630 can include any devices that process, display, and/or otherwise render audio, display, and image data. Display data and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 628 and/or the display system 630 are implemented as external components to device 600. Alternatively, the audio system 628 and/or the display system 630 are implemented as integrated components of example device 600.

Although embodiments of collected media content data have been described in language specific to features and/or methods, it is to be understood that the subject of the appended claims is not necessarily limited to the specific features or methods described. Rather, the specific features and methods are disclosed as example implementations of collected media content data.

1. A computer-implemented method, comprising:
receiving browsing inputs from a client device when a user interacts with the client device to browse media content available via the Internet;
collecting media content data associated with the media content that is displayed for viewing at the client device;
determining media items associated with the media content data;
storing identifiers of the media items that are correlated with the user; and
communicating the identifiers of the media items to a media content playback device that is associated with the user.

2. A computer-implemented method as recited in claim 1, further comprising receiving the media content data from the client device when an explicit user input at the client device initiates selection of the media content data for collection.

3. A computer-implemented method as recited in claim 1, further comprising receiving the media content data from the client device when a browser module that is implemented at the client device selects the media content data based on media tags that identify the media content data.

4. A computer-implemented method as recited in claim 1, further comprising receiving the media content data from the client device when a browser module that is implemented at the client device selects the media content data based on semantic identification of the media content data.

5. A computer-implemented method as recited in claim 1, wherein the identifiers of the media items are displayable at the media content playback device as user-selectable references to the media items.

6. A computer-implemented method as recited in claim 1, further comprising:
receiving a user selection of an identifier of a media item from the client device; and
delivering the media item that corresponds to the identifier for playback at the media content playback device.

7. A computer-implemented method as recited in claim 1, wherein the media content playback device is a television client system configured to display the identifiers of the media items for user selection to initiate playback of a media item.

8. A computer-implemented method as recited in claim 1, further comprising:
receiving additional browsing inputs from a different client device when the user interacts with the different client device to browse the media content; and
collecting additional media content data associated with the media content that is displayed for viewing at the different client device.

9. A computer-implemented method by a computing device that is configured as a client device, the method comprising:
receiving browsing inputs from an input device when a user interacts with the client device to browse media content available via the Internet;
collecting media content data associated with the media content that is displayed for viewing;
communicating the media content data to a media content service that determines media items associated with the media content data, and stores identifiers of the media items that are correlated with the user; and
receiving the identifiers of the media items for display as user-selectable references to the media items.

10. A computer-implemented method as recited in claim 9, further comprising receiving an explicit user input to select the media content data for collection.

11. A computer-implemented method as recited in claim 9, wherein the media content data is collected when a browser module that is implemented at the client device selects the media content data based on media tags that identify the media content data.

12. A computer-implemented method as recited in claim 9, wherein the media content data is collected when a browser module that is implemented at the client device selects the media content data based on semantic identification of the media content data.

13. A computer-implemented method as recited in claim 9, further comprising:
receiving a user selection of an identifier of a media item; and
rendering the media item that corresponds to the identifier for playback.

14. A system, comprising:
a media content service configured to receive browsing inputs from a client device when a user interacts with the client device to browse media content available via the Internet;
at least a memory and a processor to implement a data collection service configured to collect media content data associated with the media content that is displayed for viewing at the client device, and determine media items associated with the media content data;
a storage media configured to store identifiers of the media items that are correlated with the user; and
the media content service further configured to communicate the identifiers of the media items to a media content playback device that is associated with the user.

15. A system as recited in claim 14, wherein the data collection service is further configured to receive the media content data from the client device when an explicit user input at the client device initiates selection of the media content data for collection.

16. A system as recited in claim 14, wherein the data collection service is further configured to receive the media content data from the client device when a browser module that is implemented at the client device selects the media content data based on media tags that identify the media content data.

17. A system as recited in claim 14, wherein the data collection service is further configured to receive the media content data from the client device when a browser module that is implemented at the client device selects the media content data based on semantic identification of the media content data.

18. A system as recited in claim 14, wherein the identifiers of the media items are displayable at the media content playback device as user-selectable references to the media items.

19. A system as recited in claim 14, wherein the media content service is further configured to:
receive a user selection of an identifier of a media item from the client device; and
deliver the media item that corresponds to the identifier for playback at the media content playback device.

20. A system as recited in claim 14, wherein:
the media content service is further configured to receive additional browsing inputs from a different client device when the user interacts with the different client device to browse the media content; and
the data collection service is further configured to collect additional media content data associated with the media content that is displayed for viewing at the different client device.
